(19) United States
(12) Patent Application Publication
(10) Pub. No.: US 2010/0051530 A1
(43) Pub. Date: Mar. 4, 2010

(54) Flexible Filter With Continuously Extruded Profile Frame

(75) Inventors: Andreas Manz, Mannheim (DE); Volker Haendler, Hopkinsville, KY (US); Willie Yung, Clarksville, TN (US); Russell Meredith, White Plains, KY (US)

Correspondence Address: GROSSMAN, TUCKER, PERREAULT & PFLEGER, PLLC, 55 SOUTH COMMERICAL STREET, MANCHESTER, NH, 03101, US

(73) Assignee: Freudenberg Nonwovens, L.P., Durham, NC (US)

(21) Appl. No.: 12/200,692

(22) Filed: Aug. 28, 2008

(51) Int. Cl. B32B 3/04; B01D 35/30

(52) U.S. Cl. 210/232; 156/216

(57) ABSTRACT

A filter pack is formed of a pleated filter section and a channel that forms a frame. The filter section may be formed of a non-woven polymer material which has been pleated. The filter section may have edge banding along at least a portion of its periphery. The filter section may be retained in the frame by an adhesive. One or more filter sections may be combined to form a filter pack. The frame may be continuously formed from an extruded plastic which may be folded to provide a one, two, three or four part frame. The frame may be provided with living hinge and mechanical locking features. A foldable edge band may be provided to allow the joining of multiple filter sections into larger filter packs.

### FIELD

The present disclosure relates to a residential or commercial air filter, and more particularly, to an air filter having a relatively rigid plastic frame, produced from a continuous extrusion profile, and a method for connecting filter sections together.

### BACKGROUND

Air filters for prefiltration and final filtration for HVAC and general equipment protection may take many forms, depending on the particular application. One type of filter is a pleated filter, which is formed from a sheet of filter media folded into a series of pleats. One type of pleated filter, known as a mini-pleat filter, has smaller, closely spaced pleats. The peaks between adjacent pleats of a mini-pleat filter may be spaced less than about 20 mm apart and typically range from 5.0 mm to 7.5 mm apart. In typical applications, the pleat height may range from about 36 to about 92 mm.

A pleated filter can be made from a variety of media. The size of the filter affects the choice of media. For example, for a mini-pleat filter, fiberglass is a suitable material. A synthetic, non-woven filter media has been used, as described in U.S. Pat. Nos. 6,464,745 and 6,846,342.

In the '745 patent, the frame assembly includes a plurality of corner members and an equal plurality of side members interconnecting the corner members.

In the '342 patent, the filter section and the frame are formed of a non-woven polymer material, preferably a polyester material. The filter pack may be fully shreddable and does not require separation into various components for recycling.

### SUMMARY

In one exemplary embodiment, the present disclosure is directed at a method of forming a filter assembly. One may provide a filter frame comprising an extrudate having at least one length of extruded polymer having a profile, wherein the profile is capable of folding to form corners and/or to form a C-shaped channel. This may be followed by providing a pleated section of non-woven material, the section having sides, wherein one or more strips of edge banding are adhered to at least one of said sides of the pleated section to form a filter pack. This then may be followed by folding the extrudate along its length around said filter packs wherein one or more filter packs are mounted within said filter frame.

In another exemplary embodiment, the present disclosure provides a frame for a filter assembly comprising at least one length of extruded polymer, wherein the extruded polymer may be folded to form corners and/or to form a C-shaped channel, wherein one or more filter packs are mounted within said filter frame to form said filter assembly.

In another exemplary embodiment, the present disclosure provides a frame for a filter assembly comprising at least one length of polymer, wherein the length may be folded to form corners and/or to form a C-shaped channel; wherein one or more filter packs are mounted within said filter frame to form said filter assembly.

### BRIEF DESCRIPTION OF THE DRAWINGS

The invention will be more fully understood from the following detailed description taken in conjunction with the accompanying drawings in which:

FIG. 1 is an isometric exploded view of a filter pack according to the present invention;

FIG. 2 is a cross-sectional view of the filter pack of FIG. 1 taken through a portion of the frame;

FIG. 3 is an isometric view of a filter pack including edge bands;

FIG. 4 is a cross-sectional view illustrating a V-flap edge band;

FIG. 5 is a cross-sectional view illustrating another configuration of V-flap edge band;

FIG. 6 is a cross-sectional view of a filter pack taken through a portion of the frame wherein the frame is tapered;

FIG. 7 is a prospective view of a C-channel extrusion that may form the frame;

FIG. 8A is a cross-sectional view of a flat extrusion that may be folded to form a C-channel;

FIG. 8B is a cross-sectional view of a intermediate shaped extrusion of that may be folded to form a C-channel;

FIG. 9A is a cross-sectional view of a flat extrusion including hinge sections and locking elements; and

FIG. 9B is a cross-sectional view of the extrusion of FIG. 8B folded to form a C-shaped channel which locks.

### DETAILED DESCRIPTION

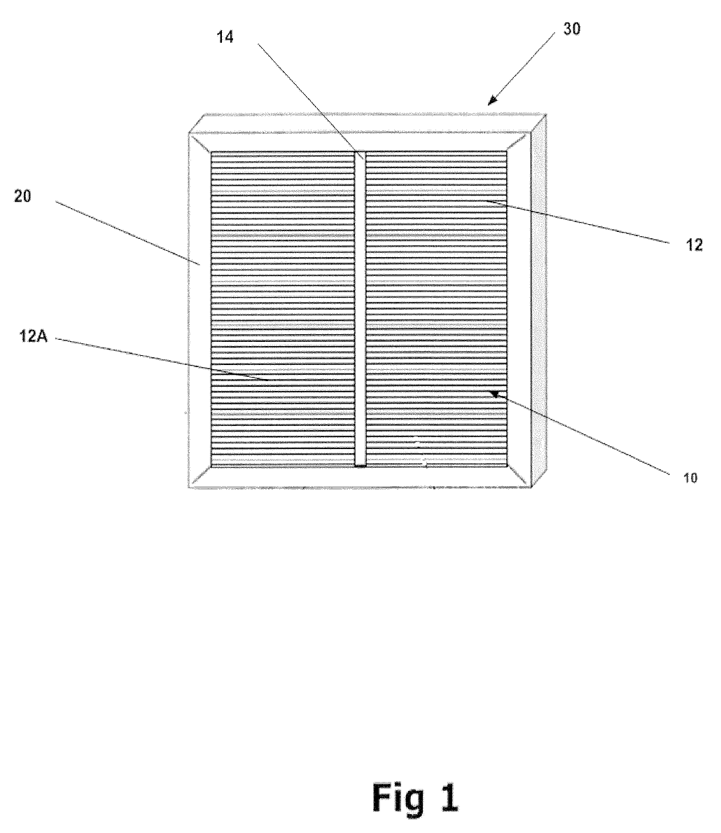

Referring to FIG. 1, a filter pack 10 according to the present invention may have a section 12, 12A of pleated filter media held in place by strips of edge banding 14 and a relatively rigid frame 20. Both the filter media pleated section and the edge banding may be formed from a non-woven material. Preferably, both the pleated section and the edge banding may be formed from the same polymer, which may be understood as reference to two polymeric materials that have the same chemical repeating unit.

A polymer such as polyester may be suitable, although other polymers may be used. In one exemplary embodiment, the pleated section may be formed from a laminate of a melt blown micro-fiber polyester inner layer and spun bond polyester outer layers, and the edge banding formed from spun-bond polyester. The melt blown micro-fiber polyester material for the inner layer of the pleated filter section may comprise a smaller fiber and may be thicker than the spun-bond polyester, providing greater filtration efficiency. The spun-bond polyester material for the outer layer may be stiffer and enable the filter section to retain its pleated form. The weight of the polyester material may typically range up to 50 g/m². Any suitable lamination process, such as an ultrasonic welding process, may be used to form the filter section lamination. The spun-bond polyester material may also used for the edge banding. The weight may be about 400 g/m².

The particular material selected for the filter section and the edge banding may depend on the application and on manufacturing considerations. Different applications may have different filtration requirements. Also, different non-woven polymer media have different properties, such as elongation and strength, which may render them unsuitable for use with different types of manufacturing equipment. For example, they may not pleat well or thread properly through the equipment.

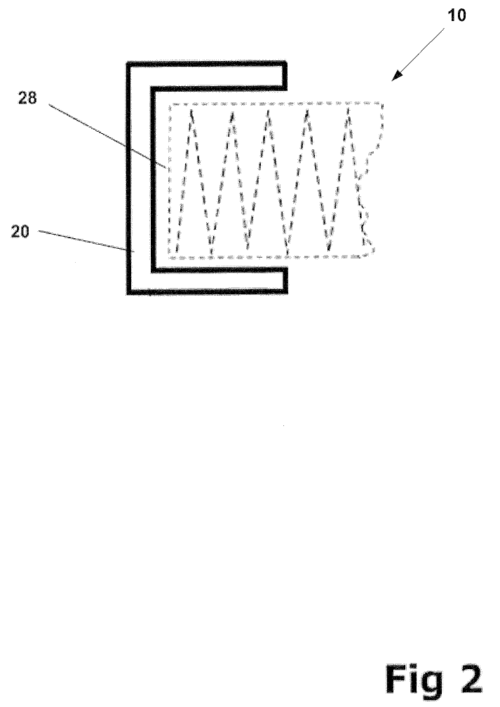

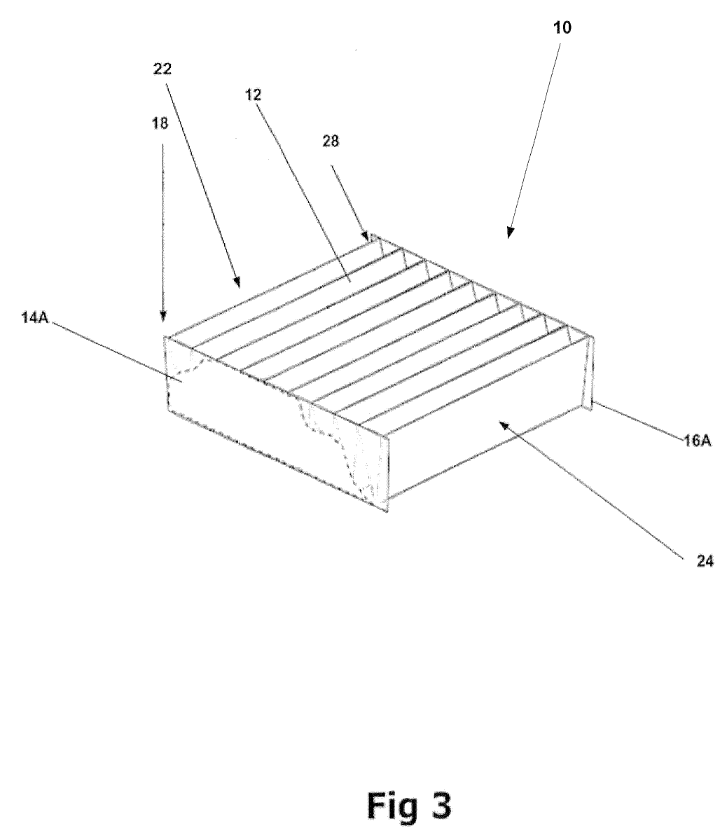

In FIG. 1, each section 12, 12A of the filter media may comprise a sheet of a non-woven material that has been pleated or folded in an accordion (zig-zag) fashion. A mini-pleat section may be suitably used in the present invention. As shown in FIG. 3, each pleated section may be held in the pleated configuration by strips of flat edge banding 14A, 16A extending along the two sides 18, 28 transverse to the pleats. The remaining two sides 22, 24 parallel to the pleats, may be left free of edge banding. As shown in FIG. 2, the frame 20 may have a channel or C-shaped cross-sectional form which may be configured into a rectangular frame which the edge banded pleated sections 12, 12A, or filter packs, 10 may be assembled into. The sides 18, 28 of the pleated section 12 may be placed within the channel and held there in any suitable manner, such as with an adhesive. Once assembled, one or more of the filter packs 10 and frame 20 may form a filter assembly 30, as shown in FIG. 1.

A glue or adhesive, such as hot-melt polyester, may be used to attach the edge banding 14A, 16A to the pleated section 12 to form a filter pack. The adhesive should be capable of forming a solid bond with the pleated filter section 12, the edge banding 14A and the frame 20 and should be compatible with the material of the pleated filter section and the edge banding. A hot-melt adhesive may be suitable and may be of the same polymer as the pleated filter section 12 and the edge banding 14A, 16A. A polyester hot-melt adhesive may be suitable when the filter section and edge banding frame are formed from a polyester material.

The edge banded filter pack 10, shown in FIG. 3, may be prefabricated for easy assembly into a filter assembly 30 which may be held together by frame 20.

A number of filter packs 10 may be attached together to form a filter assembly 30. Referring to FIG. 1, two filter packs 10 arranged in a filter assembly 30 are illustrated, although any suitable number and configuration of filter packs may be used, depending on the application. The adhesive, such as a hot-melt adhesive, may be applied along abutting faces of the edge banding to hold adjacent filter packs together.

FIG. 2 illustrates a typical cross-sectional view of a channel or C-shaped frame 20 with the pleated filter pack 10 contained within the channel and one of the sides 28 to which adhesive may be applied to secure the pack in the channel.

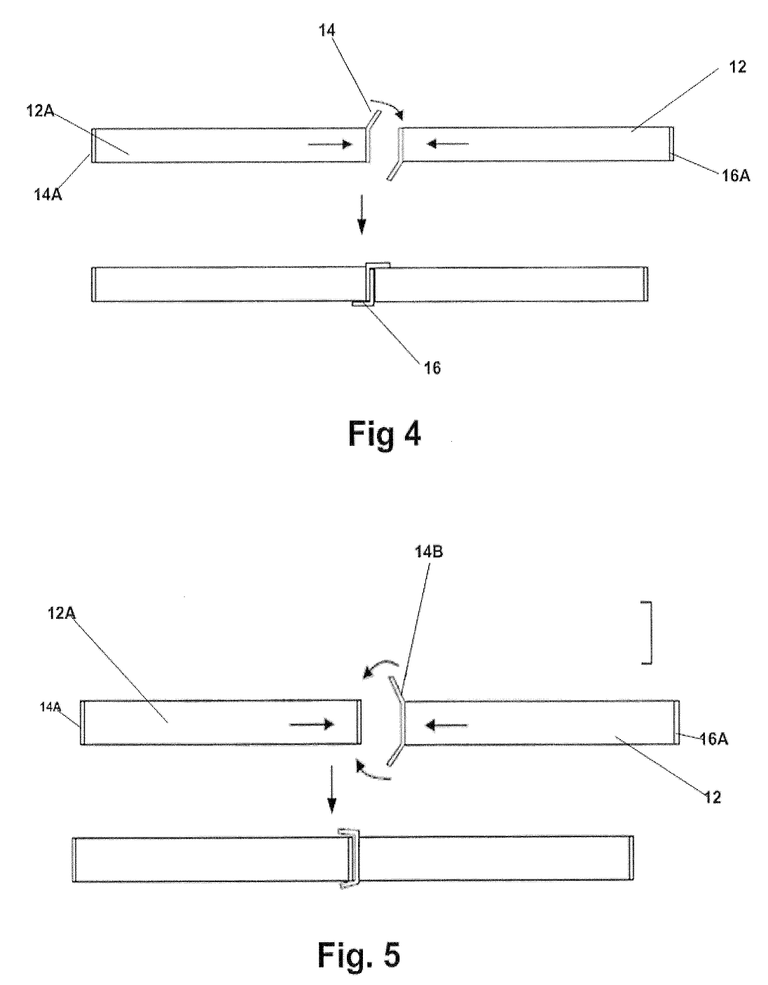

Turning to FIG. 4, two types of edge banding are shown. Flat edge banding 14A, 16A, may be adhered to the transverse sides of the pleated section 12, or a V-shaped edge band 14, 16 may be used to join together a plurality of pleated sections to form larger filter assemblies. As indicated by the arrows in FIG. 4, a pleated section 12 may be provided with a V-shaped edge banding 16, wherein the edge banding is capable of being folded. A second pleated section 12A may be provided with V-shaped edge banding 14 and the two pleated sections 12, 12A pressed together and the V-shaped edging folded onto the face of the pleated sections 12, 12A. The V-shaped edge banding 14, 16 may be wider than the filter section thickness and may fold along one or more score lines (not shown) to cover the seam between sections 12 and 12A and provide additional structural integrity to the filter pack 10 and assembly 30.

FIG. 5 illustrates another configuration of edge banding 14B which may have two flaps which may be adhered to an edge of pleated section 12 and then bent over the surface of pleated section 12A after the two sections have been pressed together. The edge banding may be of the same polymer composition as the pleated section or the edge banding may have a different polymer composition, or the edge banding may be a non-woven of a higher basis weight than the filter section 12.

Turning now to the plastic frame, the frame 20 in FIG. 1 may specifically be an extruded polymer having a selected profile, which therefore allows for continuous extrusion through a profile die. The plastic frame may therefore be prepared from a variety of thermoplastic resins, including, but not limited to, polypropylene, polyethylene, polystyrene or polyester. This may therefore provide the manufacture of a relatively low cost, relatively rigid and visually-pleasing frame in a continuous process.

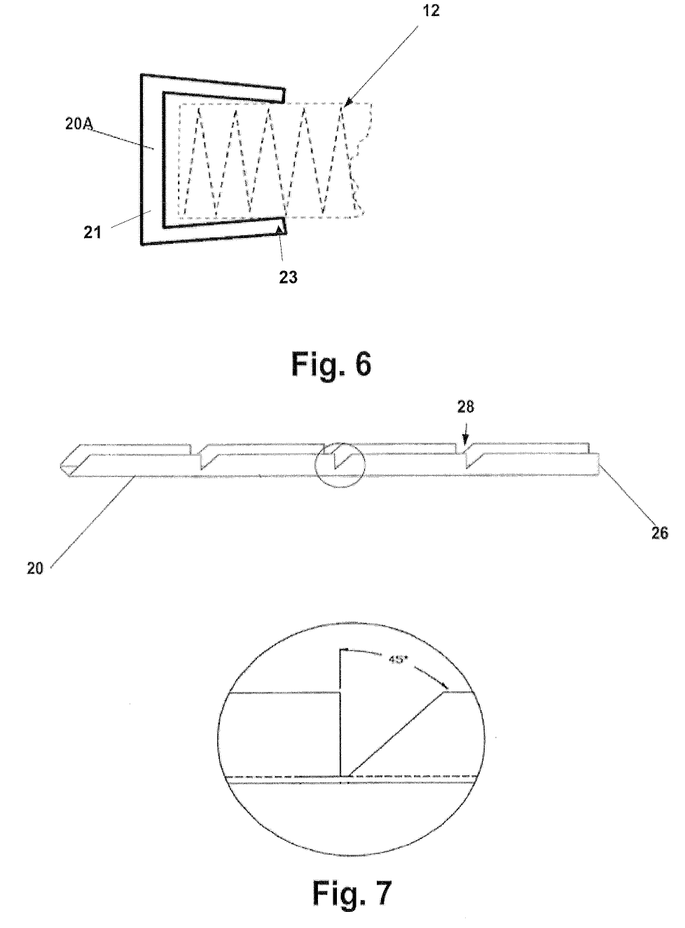

One exemplary cross-section of the frame 20 is shown in FIG. 2 wherein the extending legs of the “C” are parallel. Another exemplary cross-section of the frame 20A is shown in FIG. 6 wherein the extending legs of the “C” are converging (i.e. the open end 23 of the C-channel has a smaller width than the base 21). The width of the extruded channel may be about 1-2 inches for filter assemblies having pleated filter sections of about 1-2 inches in nominal thickness.

The frame 20, 20A may be assembled to the filter packs 10 as one, two, three or four continuously extruded pieces using, for instance an adhesive. FIG. 7 illustrates an extruded channel 20 which has been cut to length to fit around one or more filter packs. A specific pattern of V-shaped notches 28 may be provided in the channel at predetermined distances to match the size of the filter pack(s). The channel 20 may be folded at the notches 28 to provide a rectangular frame with a mitered appearance at the corners. A mitered appearance may be understood as a joint made by beveling each of the two sides to be joined, at about a 45° angle, to form a corner, which corner is at a 90° angle. The square corners, such as 26, may overlap the angled corners 28 to provide a surface for applying an adhesive. In other words, as shown in the circled enlarged view, the notches 28 may have one side cut to a 90° angle and the other side cut to a 45° angle relative to the length of the channel 20. When folding the frame around a filter pack, the 45° sides may slide over the 90° sides. The end of the extrusion 26 may be cut square. In another exemplary embodiment, the ends and notches may have a 90° cut on one leg of the channel and a 45° cut on the other leg. It is contemplated that the frame 20 may be formed from one, two, three or four pieces of the extruded C-channel configuration. It is further contemplated that the channel may be formed by other plastic forming processes, such as, but not limited to, injection molding, compression molding, transfer molding and pultrusion. Accordingly, in the case of pultrusion, it is contemplated herein that the frame may be sourced from thermoset type resins and one may therefore continuous draw fibers through a thermoset bath containing crosslinkable monomers or oligomers followed by a die to impose the profile frame shape for the filter frame noted herein.

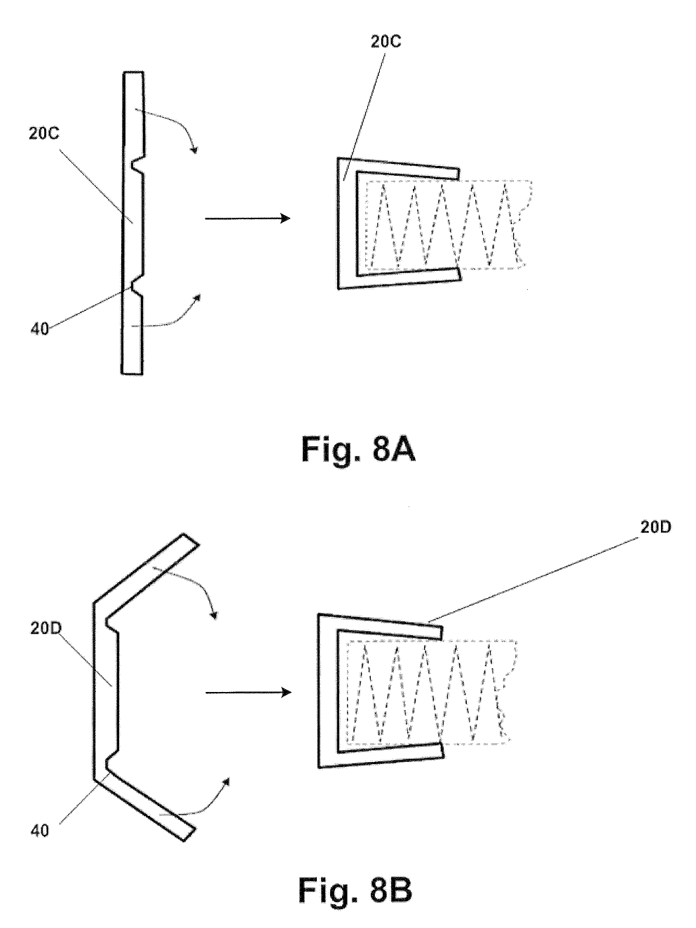

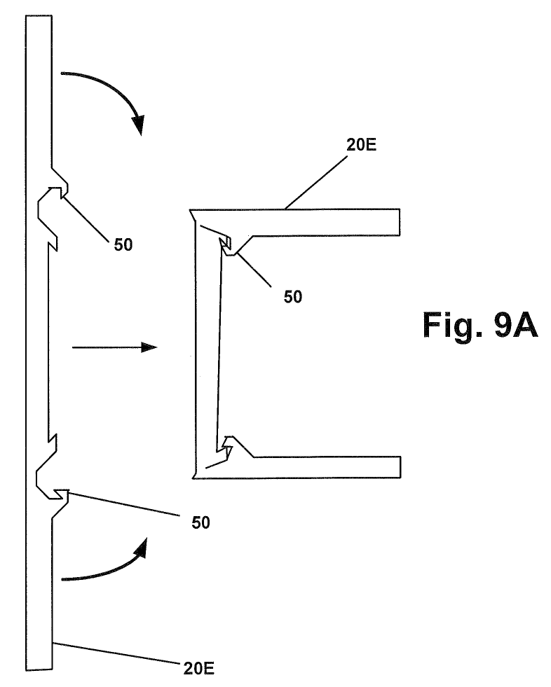

FIG. 8A illustrates a flat extrusion profile that is continuously produced which may then be folded (as indicated by the arrows) to form a C-channel 20C. A flat extrusion profile may be understood herein as a profile that if formed in a single plane. The flat extrusion may include grooves 40 along the length to act as folding planes, or living hinges, to aid in shaping the channel in a manual or automated process. A living hinge may be understood herein as a hinge that may undergo successive folding without failure, which living hinge is typically formed from polypropylene type material.

FIG. 8B illustrates an angled extrusion which may be folded (as indicated by the arrows) to form a C-channel 20D. The angled extrusion (i.e. an extrudate that that is formed in two planes) may include grooves 40 along the length to act as folding planes, or living hinges, to aid in shaping the channel in a manual or automated process. Again, the folded frame may include notches to form corners and be attached along the edges of a filter pack by adhesive.

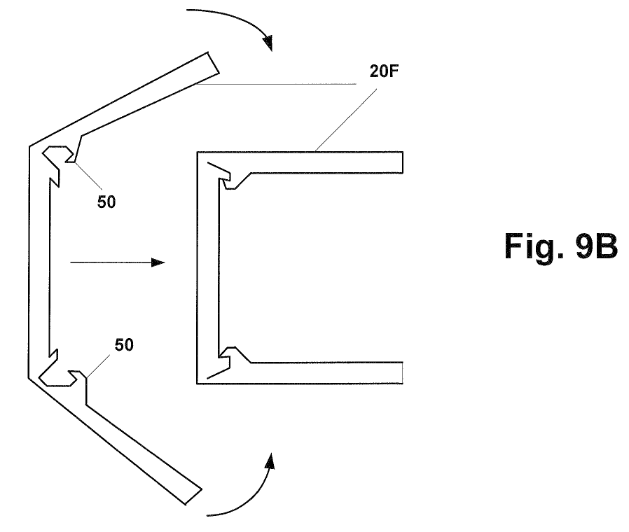

It is also contemplated that a locking mechanism may be integrated into the channel to aid in attaching the frame to the filter pack. This is illustrated in FIGS. 9A and 9B. FIG. 9A illustrates a flat plastic extrusion 20E which includes a profile having angled projections 50 which are designed to interlock together when the extrusion is folded to shape. FIG. 9B illustrates an angled plastic extrusion 20F which includes a profile having angled projections 50, which are designed to interlock together when the extrusion is folded to shape.

The filter pack assembly may then be assembled in the following manner. The edge banding material may typically be supplied in a roll. A length of the edge banding material may be unrolled, scored along two longitudinal lines, and bent along the score lines to connect filter packs together. A hot melt adhesive may be deposited on the edge banding 14, 16 by suitable equipment. Concurrently, the filter section material, which is also typically supplied in a roll, may be unrolled and pleated at suitable pleating machinery. The pleated material may be cut transversely to the pleats to form filter sections 12, 12A of the appropriate size at suitable cutting equipment. The edge banding may be adhesively attached to the desired sides of the pleated filter sections and cut at the ends of the side so that the strip is as long as the corresponding side of the pleated filter section. Alternatively, the strips 14, 16 may be cut to an appropriate length first and then adhesively applied to the filter section 12, 12A.

The filter packs 10 may be mounted within the frame 20 as follows. For example, a double-sided adhesive tape may be applied along the inside face of two opposing side members. The flat side faces 14A, 16A at the edges of the pleated filter media may be adhered to the outwardly facing surface of the tape. A polyurethane adhesive may then be applied within the channel along the inside faces of the remaining two opposing side members. The edges of the pleated filter media forming a row of V-shapes may be pressed into the polyurethane adhesive. If desired, a narrow band may be glued or otherwise affixed across the pleats to assist in maintaining an even pleat spacing. The extruded channel may be formed around the filter packs and the ends connected and the adhesive allowed to set-up or cure.

The invention is not to be limited by what has been particularly shown and described except as indicated by the appended claims.

What is claimed is:

1. A method of forming a filter assembly comprising:
providing a filter frame comprising an extrudate having at least one length of extruded polymer having a profile, wherein the profile is capable of folding to form corners and/or to form a C-shaped channel;
providing a pleated section of non-woven material, the section having sides;
wherein one or more strips of edge banding are adhered to at least one of said sides of the pleated section to form a filter pack;
folding said extrudate along its length around said filter packs wherein one or more filter packs are mounted within said filter frame.

2. The method of claim 1 wherein said frame includes V-notches which are located at longitudinal folding points along the extrusion to provides a mitered corner appearance.

3. The method of claim 2 wherein said V-notches comprise at least one 45° angle.

4. The method of claim 1 wherein said frame may comprise 2, 3 or 4 individually joined sections.

5. The method of claim 1 wherein said C-shaped channel includes converging legs.

6. The method of claim 1 wherein an adhesive is used to attach the folded C-shaped channel at the folding points.

7. The method of claim 1 wherein said extrudate having a profile is formed in a single plane.

8. The method of claim 1 wherein said extrusion is C-shaped.

9. The method of claim 1 wherein said edge banding may comprise a non-woven material.

10. The method of claim 1 wherein said edge banding includes an adhesive to attach a plurality of filter packs, said filter packs separated by a seam.

11. The method of claim 10 wherein said edge banding may include a V-flap, said V-flap foldable to cover said seam.

12. The method of claim 1 wherein said extruded polymer comprises polypropylene, polyethylene, polystyrene or polyester.

13. The method of claim 7 wherein said extrudate has a length and includes grooves along said length, said grooves acting as folding planes to aid in folding said extrudate into a C-shape.

14. The method of claim 7 wherein said extrudate includes a profile including a plurality of angled projections longitudinally along its length, said projections designed to interlock with one another to hold said extrudate in a C-shape.

15. The method of claim 8 wherein said extrudate includes a profile including a plurality of angled projections longitudinally along its length, said projections designed to interlock with one another to hold said extrusion in a C-shape.

16. The method of claim 13 wherein said grooves act as a living hinge.

17. The method of claim 1 wherein said wherein said pleated section of non-woven material comprises a non-woven material.

18. A frame for a filter assembly comprising at least one length of extruded polymer, wherein the extruded polymer may be folded to form corners and/or to form a C-shaped channel; wherein one or more filter packs are mounted within said filter frame to form said filter assembly.

19. The frame of claim 18 wherein said filter packs are held in said C-shaped channel with an adhesive.

20. A frame for a filter assembly comprising at least one length of polymer, wherein the length may be folded to form corners and/or to form a C-shaped channel, wherein one or more filter packs are mounted within said filter frame to form said filter assembly.
